(19) United States
(12) Patent Application Publication
(10) Pub. No.: US 2017/0052839 A1
(43) Pub. Date: Feb. 23, 2017

(54) MEMORY SYSTEM

(71) Applicant: SK hynix Inc., Gyeonggi-do (KR)

(72) Inventors: Jong-Bum PARK, Gyeonggi-do (KR); Yong-Kee KWON, Gyeonggi-do (KR); Yong-Ju KIM, Gyeonggi-do (KR)

(21) Appl. No.: 14/982,412

(22) Filed: Dec. 29, 2015

(30) Foreign Application Priority Data
Aug. 21, 2015 (KR) 10-2015-0117873

(51) Int. Cl. G06F 11/07

(52) U.S. Cl. CPC G06F 11/0793; G06F 11/0727; G06F 11/076

(57) ABSTRACT

A memory system may include a memory module including a plurality of memory devices suitable for storing a data word containing multi-bit data, and a memory controller suitable for controlling a write operation and a read operation of the memory module and distributing and mapping the data word to the plurality of memory devices, wherein as a memory device has a higher error occurrence count among the memory devices, the controller maps higher-significant bits of the multi-bit data to the memory device.

### CROSS REFERENCE TO RELATED APPLICATIONS

The application claims priority of Korean Patent Application No. 10-2015-0117873, filed on Aug. 21, 2015, which is incorporated herein by reference in its entirety.

### BACKGROUND

1. Field

Exemplary embodiments of the invention relate to a memory system including a memory device and a memory controller.

2. Description of the Related Art

Memory devices include a plurality of memory cells for storing data. Each memory cell may include a transistor serving as a gate controlling the flow of data to and from the memory cell and a capacitor for storing the data in the form of electrical charges. Depending on whether an electrical charge is stored in the memory cell or whether the terminal voltage of the capacitor is high or low, the data stored in the memory cell may be divided into a high (logic 1) and low logic (logic 0). Generally, while data is stored, no power is consumed and the stored data is maintained unchanged in the memory cells. However, the initial charge stored in the capacitor of each memory cell may be gradually be dissipated due to a leakage current occurring in a typical PN junction of a MOS transistor, resulting in the loss of data. In order to prevent such a data loss, the stored data are read and the memory cells are recharged based on the read data, before the data is lost. Such a process is referred to as a refresh operation and may be repeated periodically at regular preset refresh intervals.

The leakage amount of the charge stored in the capacitor of each memory cell may vary depending upon various factors such as temperature, process, and voltage which may vary within different regions of a memory. That is, the data retention time of each memory cell may vary. As the data retention time of each memory cell may vary, data stored in some memory cells may be lost during a refresh interval. Such an error is commonly referred to as a Variable Retention Time (VRT) error.

In general, memory devices have different process variables and difference characteristics during a packaging process. For example during the packaging process, different memory devices or memory regions of a memory may be exposed to high heat, while other memory devices may be exposed to low heat. Such variables have a great influence on the probability of the VRT error occurring in the memory devices. As a result, the VRT error may occur in a memory device at different rates.

### SUMMARY

Various embodiments are directed to a technology for stably operating memory devices in a memory module even though the memory devices have different error rates.

In an embodiment, a memory system may include a memory module including a plurality of memory devices suitable for storing a data word containing multi-bit data, and a memory controller suitable for controlling a write operation and a read operation of the memory module and distributing and mapping the data word to the plurality of memory devices, wherein as a memory device has a higher error occurrence count among the memory devices, the controller maps higher-significant bits of the multi-bit data to the memory device.

The error occurrence count may include a VRT (variable retention time) error occurrence count.

The memory module may further include an information storage device suitable for storing error occurrence counts of the memory devices, and the memory controller may receive the error occurrence counts of the memory devices from the information storage device.

The memory controller may include a host interface suitable for communicating with a host, a data buffer suitable for storing the data word between the host and the memory module, a scheduler suitable for setting an operation sequence of the memory module, a command generator suitable for generating a command to be applied to the memory module, a memory interface suitable for communicating with the memory module an error history storage unit suitable for storing the error occurrence counts of the memory devices, and a mapping unit suitable for mapping the data word to the memory devices.

In an embodiment, a memory system may include a memory module including a plurality of memory devices suitable for storing first to Nth data words each containing multi-bit data, where N is an integer equal to or more than 2, and a memory controller suitable for controlling a write operation and a read operation of the memory module and distributing and mapping the first to Nth data words to the plurality of memory devices, wherein as a memory device has a higher error occurrence count among memory devices mapped to a Kth data word among the first to Nth data words, the controller maps higher-significant bits of the multi-bit data of the Kth data word to the memory device.

In an embodiment a memory system may include a memory module including a plurality of memory devices suitable for storing one or more data words and error sensing information of the one or more data words, the data word containing multi-bit data, and a memory controller suitable for controlling a write operation and a read operation of the memory module and distributing and mapping the one or more data words and the error sensing information to the plurality of memory devices wherein one or more memory devices having a low error occurrence count among the plurality of memory devices are mapped to the error sensing information.

In an embodiment, a memory system may include a memory module comprising a plurality of memory devices having respective error occurrence counts and storing a data word containing multi-bit data, and a memory controller suitable for controlling a write operation and a read operation of the memory module and distributing and mapping the data word to the plurality of memory devices, based on the error occurrence counts.

memory device has a higher error occurrence count among the memory devices, the controller may map higher-significant bits of the multi-bit data to the memory device.

In an embodiment, a method of operating a memory system comprising a controller and a plurality of memory devices, the method may include the controller distributing multi bits of data to the memory devices based on their respective error occurrence counts.

As a memory device has a higher error occurrence count among the memory devices, the controller may map higher-significant bits of the multi-bit data to the memory device.

### BRIEF DESCRIPTION OF THE DRAWINGS

FIG. 1 is a configuration diagram of a memory system, according to an embodiment of the invention.

FIG. 2 is a diagram illustrating an example of an initial mapping between data words and memory devices shown in FIG. 1.

FIG. 3 is a diagram illustrating an example of a mapping between data words and memory devices after a mapping operation of a mapping unit 117 shown in FIG. 1.

FIG. 4 is a configuration diagram of a memory system, according to another embodiment of the invention.

FIG. 5 is a diagram illustrating an example of an initial mapping between data words and memory devices shown in FIG. 4.

FIG. 6 is a diagram illustrating an example of a mapping between data words and memory devices after a mapping operation of a mapping unit 117 shown in FIG. 4.

### DETAILED DESCRIPTION

Various embodiments will be described below in more detail with reference to the accompanying drawings. The invention may, however, be embodied in different forms and should not be construed as limited to the embodiments set forth herein. Rather, these embodiments are provided so that this disclosure will be thorough and complete, and convey the invention to those skilled in the art. Throughout the disclosure like reference numerals refer to like parts throughout the various figures and embodiments of the invention.

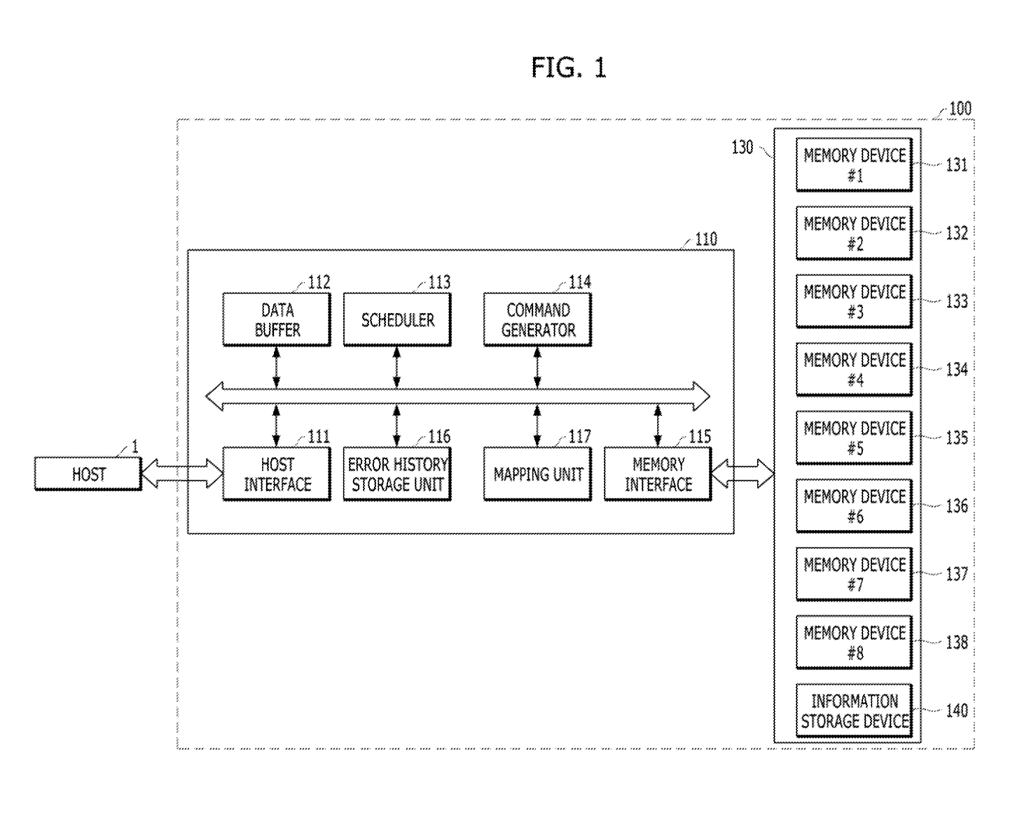

FIG. 1 is a configuration diagram of a memory system in accordance with an embodiment of the invention.

Referring to FIG. 1, the memory system 100 may include a memory controller 110 and a memory module 130. A host 1 may be operatively coupled with the memory system 100.

The memory module 130 may include a plurality of memory devices 131 to 138. During a write operation of the memory module 130, data may be written to the plurality of memory devices 131 to 138 at the same time. During a read operation of the memory module 130, data may be read from the plurality of memory devices 131 to 138 at the same time. The memory module 130 may include an information storage device 140. The information storage device 140 may store information on the number, capacities, and to performance parameters of the memory devices 131 to 138 mounted in the memory module 130, and provide the stored information to the memory controller 110. The information storage device 140 may include a SPD (Serial Presence Detect) chip. The information storage device 140 may store an error occurrence history of the memory devices 131 to 138 within the memory module 130. When manufacturing the memory devices 131 to 138, the memory manufacturer may perform various tests for the memory devices 131 to 138 and store their error occurrence histories in the information storage device 140. Furthermore, under control of the memory controller 110, a test for the memory devices 131 to 138 may be performed. As a result, the error occurrence histories of the memory devices 131 to 138 may be stored in the information storage device 140. At this time, the error occurrence history may indicate a VRT error occurrence count (referred to as an error occurrence count). The memory module 130 may include a DIMM (Dual In Line Memory Module).

The memory controller 110 may control various operations such as write and read operations of the memory module 130 on a request of the host 1. The memory controller 110 may include a host interface 111, a data buffer 112, a scheduler 113, a command generator 114, a memory interface 115, an error history storage unit 116, and a mapping unit 117.

The host interface 111 may serve as an interface between the memory controller 110 and the host 1. Through the host interface 111, a request of the host 1 may be received from the host 1, and a processing result for the request of the host 1 may be transmitted to the host 1.

The data buffer 112 may temporarily store a data word to be written to the memory module 130 and a data word read from the memory module 130.

The scheduler 113 may set the sequence of requests to be issued to the memory module 130 among the requests received from the host 1. For improving the performance of the memory system 100, the scheduler 113 may direct corresponding operations to the memory module 130 at a different sequence from the sequence of the received requests from the host 1. For example, although the host 1 may requests a read operation followed by a write operation for the memory module 130, the scheduler 113 may adjust the sequence of the operations such that the write operation for the memory module 130 is performed first before the read operation.

The command generator 114 may generate a command to be applied to the memory module 130 according to the operation sequence set by the scheduler 113.

The memory interface 115 may serve as an interface between the memory controller 110 and the memory module 130. Through the memory interface 115, a command and an address may be transmitted to the memory module 130 from the memory controller 110, and data words may be exchanged between the memory controller 110 and the memory module 130. Furthermore, through the memory interface 115, stored information in the information storage device 140 may be transmitted to the memory controller 110. The memory interface 115 may also be referred to as a PHY interface.

The error history storage unit 116 may store the error occurrence counts of the memory devices 131 to 138 received from the information storage device 140 of the memory module 130.

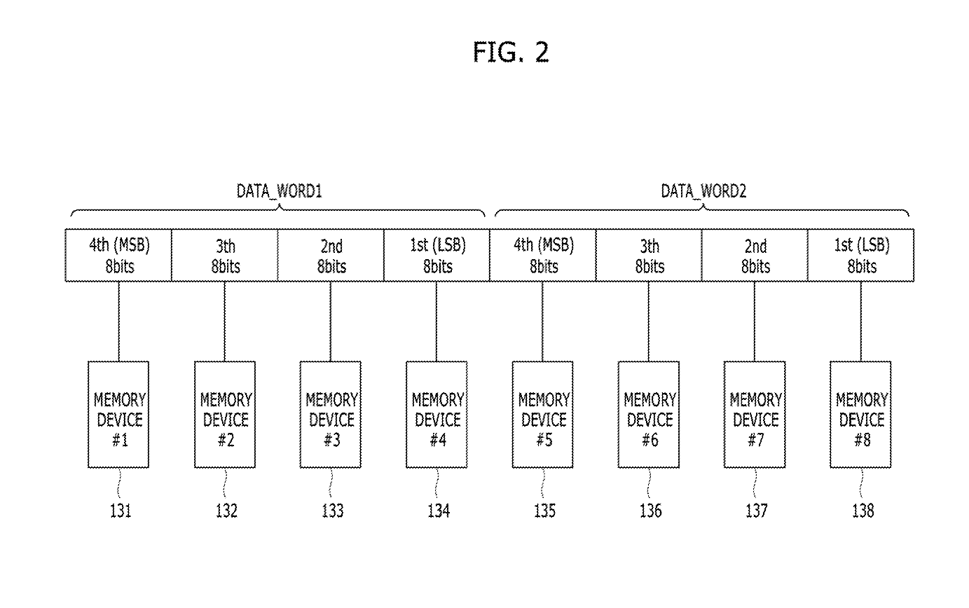

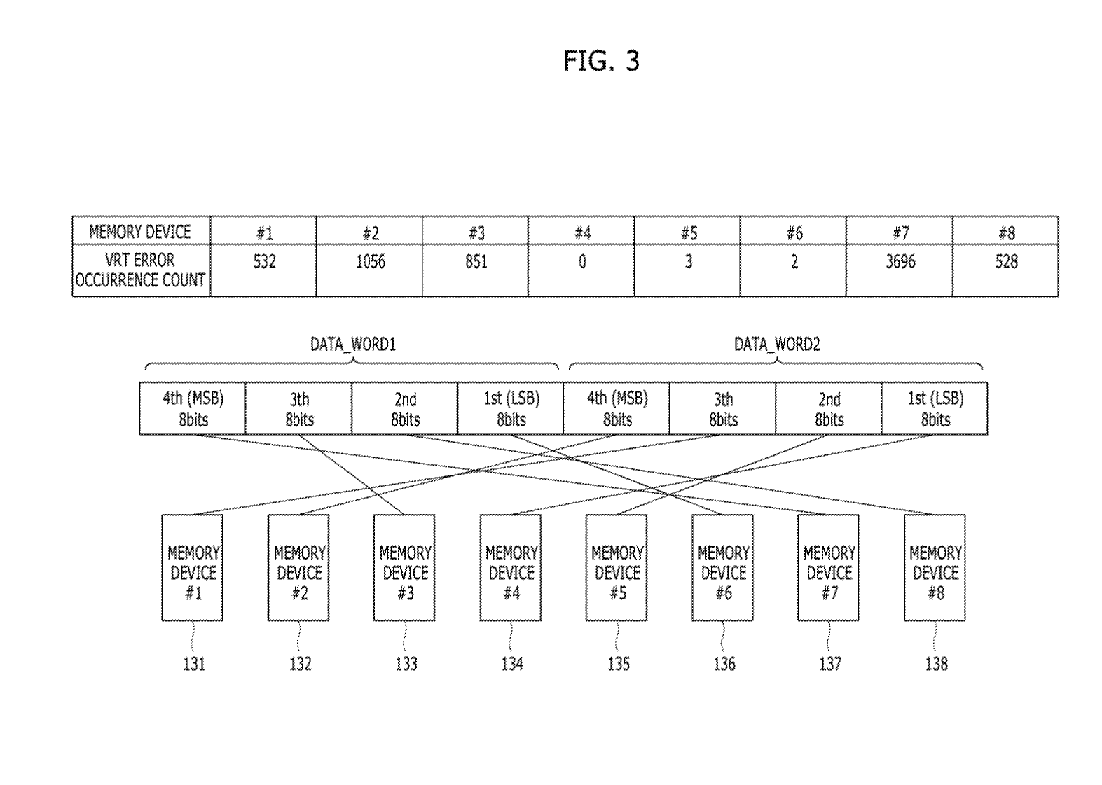

The mapping unit 117 may map a data word containing multi-bit data to the memory devices 131 to 138 of the memory module 130. The mapping unit 117 may use the error occurrence counts of the memory devices 131 to 138, stored in the error history storage unit 116, during the mapping operation. The mapping unit 117 may map a memory device having a relatively high error occurrence count to the MSBs (Most Significant Bits) of the data word, and map a memory device having a relatively low error occurrence count to the LSBs (Least Significant Bits) of the data word, among the memory devices 131 to 138. The mapping operation of the mapping unit 117 may be performed during a boot-up process of the memory system 100. The mapping operation of the mapping unit 117 will now be described in more detail with reference to FIGS. 2 and 3.

FIG. 2 is a diagram illustrating the initial mapping between data words and the memory devices shown in FIG. 1. That is, FIG. 2 illustrates mapping between the data words DATA_WORD1 and DATA_WORD2 and the memory devices 131 to 138, before a mapping operation is performed. Hereafter, it is described as an example that two data words DATA_WORD1 and DATA_WORD2 may be distributed and stored in the memory devices 131 to 138 and each of the data word words DATA_WORD1 and DATA_WORD2 may have 32 bits. However, this is only an example, and the number of data words and the bit number of the data word may vary.

Referring to FIG. 2, the first data word DATA_WORD1 may be mapped to the first to fourth memory devices 131 to 134. The MSBs of the first data word DATA_WORD1 may be mapped to the first memory device 3 The following bits of the first data word DATA_WORD1 may be sequentially mapped to the second and third memory devices 132 and 133. The LSBs of the first data word DATA_WORD1 may be mapped to the fourth memory device 134. Since the first data word DATA_WORD1 has 32 bits, the 8 bits of the first data word DATA_WORD1 may be mapped to each of the memory devices 131 to 134.

The second data word DATA_WORD2 may be mapped to the fifth to eighth memory devices 135 to 138. The MSBs of the second data word DATA_WORD2 may be mapped to the fifth memory device 135. The following bits of the second data word DATA_WORD2 may be sequentially mapped to the sixth and seventh memory devices 136 and 137. The LSBs of the second data word DATA_WORD2 may be mapped to the eighth memory device 138. Since the second data word DATA_WORD2 has 32 bits, the 8 bits of the second data word DATA_WORD2 may be mapped to each of the memory devices 135 to 138.

FIG. 3 is a diagram illustrating mapping between the data words and the memory device after a mapping operation of the mapping unit 117 shown in FIG. 1. FIG. 3 also illustrates the error occurrence counts of the memory devices 131 to 138.

Referring to FIG. 3, the fourth memory device 134 having the lowest error occurrence count may be mapped to the LSBs of the second data word DATA_WORD2 and the sixth memory device 136 having the second lowest error occurrence count may be mapped to the LSBs of the first data word DATA_WORD1. The fifth memory device 135 having the third lowest error occurrence count may be mapped to the second LSBs of the second data word DATA_WORD2, and the eighth memory device 138 having the fourth lowest error occurrence count may be mapped to the second LSBs of the first data word DATA_WORD1. That is, memory devices having low error occurrence counts may be mapped to low-order bits of the data words DATA_WORD1 and DATA_WORD2.

The memory devices 133, 136, 137 and 138 may be mapped to the first data word DATA_WORD1. Among the memory devices 133, 136, 137, and 138 the seventh memory device 137 having the highest error occurrence count may be mapped to the MSBs, and the sixth memory device 136 having the lowest error occurrence count may be mapped to the LSBs.

The memory devices 131, 132, 134, and 135 may be mapped to the second data word DATA_WORD2. Among the memory devices 131 132, 134, and 135, the second memory device 132 having the highest error occurrence count may be mapped to the MSBs and the fourth memory device 134 having the lowest error occurrence count may be mapped to the LSBs.

In general, the low-order bits of a data word may be often changed and are highly likely to have a value of ‘1’. Furthermore, the high-order bits of a data word may be less often changed, and is highly likely to have a value of ‘0’. In a memory device, an error or particularly a VRT error occurs more frequently when data is often changed or has a value of ‘1’. Thus, the low-order bits of the data word may be mapped to a memory device having a low error occurrence count, and the high-order bits of the data word may be mapped to a memory device having a high error occurrence count, which may stabilize the entire operation of the memory module.

FIG. 3 illustrates that a memory device mapped to the second data word DATA_WORD2 has a lower error occurrence count than a memory device mapped to the first data word DATA_WORD1 at the same bits (for example, MSBs). However, the mapping between the first data word DATA_WORD1 and the second data word DATA_WORD2 may have no priority, and the memory device mapped to the second data word DATA_WORD2 may have a higher error occurrence count than the memory device mapped to the first data word DATA_WORD1 at the same bits (for example, MSBs).

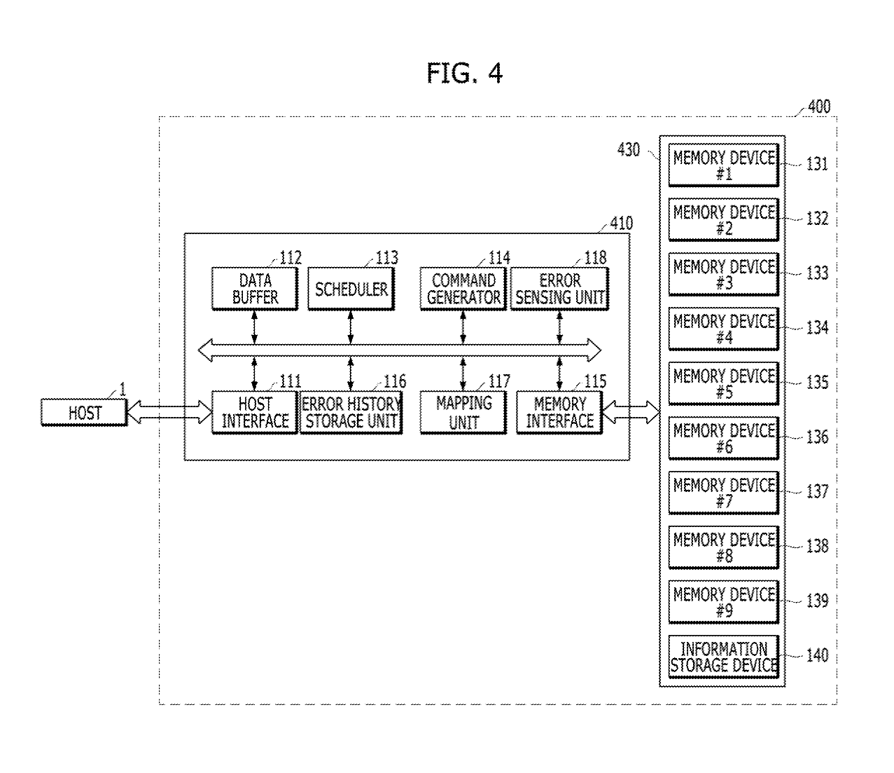

FIG. 4 is a configuration diagram of a memory system in accordance with another embodiment of the invention.

Referring to FIG. 4 the memory system 400 may include a memory controller 410 and a memory module 430. The memory system 400 may additionally include an error sensing and correction function, compared to the memory system 100 of FIG. 1.

The memory module 430 may include one more memory device 139, compared to the memory module 130 of FIG. 1. This is because the memory module 430 may store error sensing information in addition to the data words DATA_WORD1 and DATA_WORD2. The error sensing information may include information for sensing errors of the data words DATA_WORD1 and DATA_WORD2 or correcting the sensed errors. The error sensing information may include an ECC (Error Correction Code) or parity bits.

The memory controller 410 may further include an error sensing unit 118, compared to the memory controller 110 of FIG. 1. The error sensing unit 118 may generate error sensing information to be written to the memory module 430 using the data words DATA_WORD1 and DATA_WORD2 to be written to the memory module 430. The memory controller 410 may sense errors of the data words DATA_WORD1 and DATA_WORD2 read from the memory module 430 or correct the sensed error using the error sensing information read from the memory module 430. For example, in an embodiment, depending on the design of a memory controller 410, the error sensing unit 118 may only sense an error. In yet another, embodiment the error sensing unit 118 may sense an error and then correct the sensed error.

The mapping unit 117 of the memory controller 410 may map the error sensing information as well as the data words DATA_WORD1 and DATA_WORD2 to the memory devices 131 to 139. The mapping unit 117 may map the error sensing information to the memory device having the lowest error occurrence count. That is because, since the error sensing information is used to sense and correct the errors of the data words DATA_WORD1 and DATA_WORD2, the reliability of the error sensing information is the most important.

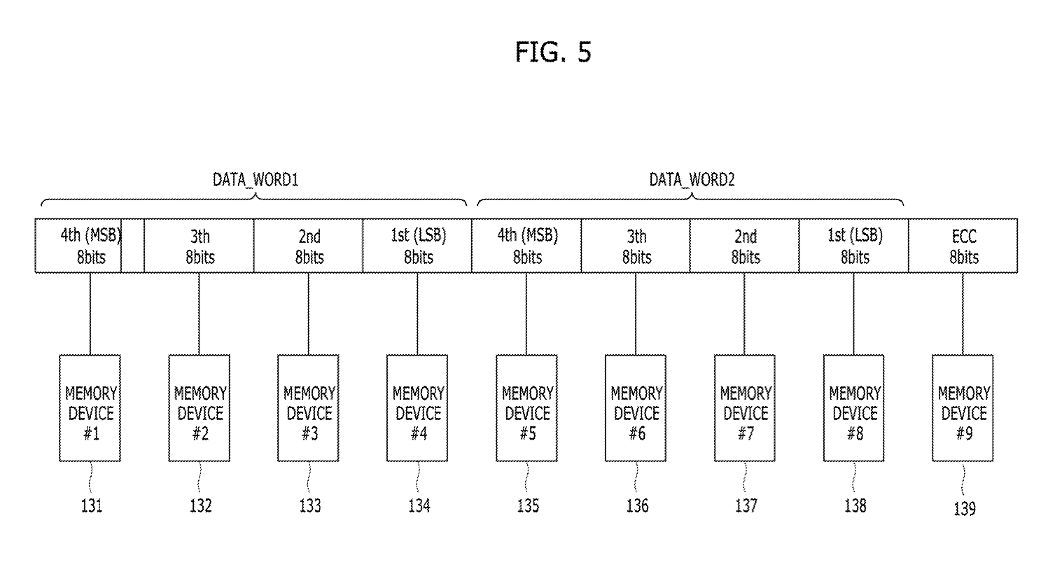

FIG. 5 is a diagram illustrating an initial mapping between the data words and the memory devices shown in FIG. 4.

Referring to FIG. 5, the data words DATA_WORD1 and DATA_WORD2 may be mapped to the memory devices 131 to 138 in the same manner as FIG. 2. The error sensing information ECC may be mapped to the memory device 139. FIG. 5 illustrates that the error sensing information ECC has 8 bits.

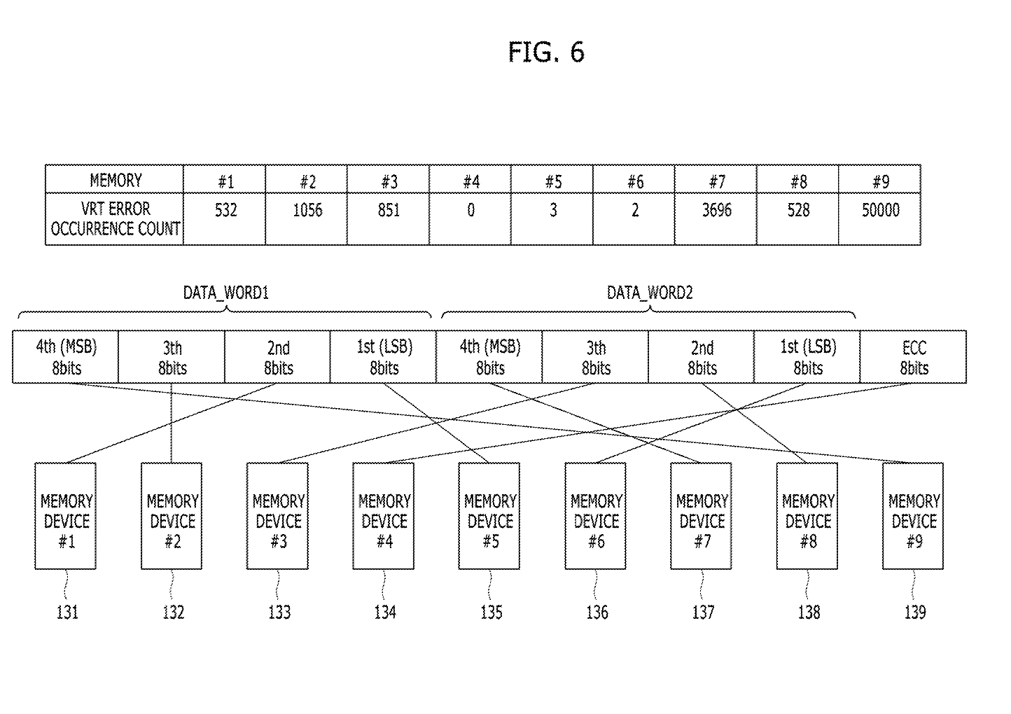

FIG. 6 is a diagram illustrating mapping between the data words and the memory devices after the mapping operation of the mapping unit 117 shown in FIG. 4. FIG. 6 also illustrates the error occurrence counts of the memory devices 131 to 139.

Referring to FIG. 6, the fourth memory device 134 having the lowest error occurrence count may be mapped to the error sensing information ECC. Furthermore, the other memory devices 131 to 133 and 135 to 139 may be mapped in the same manner as FIG. 3. That is, the other memory devices 131 to 133 to 135 to 139 may be mapped from the low-order bits to the high-order bits of the data words DATA_WORD1 and DATA_WORD2 in the ascending order of the error occurrence counts.

Such a mapping operation may reduce the probability of an error occurring in the error sensing information ECC which is the most important information. The low-order bits of the data words DATA_WORD1 and DATA_WORD2 may be mapped to a memory device having a low error occurrence count, and the high-order bits of the data words DATA_WORD1 and DATA_WORD2 may be mapped to a memory device having a high error occurrence count, which may stabilize the entire operation of the memory module 430.

In accordance with embodiments of the invention, a memory system is provided which includes a plurality of memory devices within a memory module wherein the memory devices may be stably operated even though the memory devices may have different error rates.

Although various embodiments have been described for illustrative purposes, it will be apparent to those skilled in the art that various changes and modifications may be made without departing from the spirit: and scope of the invention as defined in the following claims.

What is claimed is:

1. A memory system comprising:
a memory module comprising a plurality of memory devices suitable for storing a data word containing multi-bit data; and
a memory controller suitable for controlling a write operation and a read operation of the memory module and distributing and mapping the data word to the plurality of memory devices,
wherein as a memory device has a higher error occurrence count among the memory devices, the controller maps higher-significant bits of the multi-bit data to the memory device.

2. The memory system of claim 1, wherein the error occurrence co Lint comprises a VRT (variable retention time) error occurrence count.

3. The memory system of claim 1, wherein the memory module further comprises:
an information storage device suitable for storing error occurrence counts of the memory devices,
wherein the memory controller receives the error occurrence counts of the memory devices from the information storage device.

4. The memory system of claim 1 wherein the memory controller comprises:
a host interface suitable for communicating with a host;
a data buffer suitable for storing the data word between the host and the memory module;
a scheduler suitable for setting an operation sequence of the memory module;
a command generator suitable for generating a command to be applied to the memory module;
a memory interface suitable for communicating with the memory module;
an error history storage unit suitable for storing the error occurrence counts of the memory devices; and
a mapping unit suitable for mapping the data word to the memory devices.

5. A memory system comprising:
a memory module comprising a plurality of memory devices suitable for storing first to Nth data words each containing multi-bit data, where N is an integer equal to or more than 2; and
a memory controller suitable for controlling a write operation and a read operation of the memory module and distributing and mapping the first to Nth data words to the plurality of memory devices,
wherein as a memory device has a higher error occurrence count among memory devices mapped to a Kth data word among the first to Nth data words, the controller maps higher-significant bits of the multi-bit data of the Kth data word to the memory device.

6. The memory system of claim 5, wherein the error occurrence count comprises a VRT (variable retention time) error occurrence count.

7. The memory system of claim 5, wherein the memory module further comprises:
an information storage device suitable for storing error occurrence counts of the memory devices,
wherein the memory controller receives the error occurrence counts of the memory devices from the information storage device,

8. The memory system of claim 5, wherein the memory controller comprises:
a host interface suitable for communicating with a host;
a data buffer suitable for storing the first to Nth data words between the host and the memory module;
a scheduler suitable for setting an operation sequence of the memory module;
a command generator suitable for generating a command to be applied to the memory module;
a memory interface suitable for communicating with the memory module;
an error history storage unit suitable for storing the error occurrence counts of the memory devices; and
a mapping unit suitable for mapping the first to Nth data words to the memory devices.

9. A memory system comprising:
a memory module comprising a plurality of memory devices suitable for storing one or more data words and error sensing information of the one or more data words, the data word containing multi-bit data; and
a memory controller suitable for controlling a write operation and a read operation of the memory module and distributing and mapping the one or more data words and the error sensing information to the plurality of memory devices,
wherein one or more memory devices having a low error occurrence count among the plurality of memory devices are mapped to the error sensing information.

10. The memory system of claim 9, wherein the error occurrence count comprises a VRT variable retention time) error occurrence count.

11. The memory system of claim 9, wherein the memory module further comprises:
an information storage device suitable for storing error occurrence counts of the memory devices,
wherein the memory controller receives the error occurrence counts of the memory devices from the information storage device.

12. The memory system of claim 9, wherein the memory controller comprises:
a host interface suitable for communicating with a host;
a data buffer suitable for storing one or more first data words to be written to the memory module and one or more second data words read from the memory module;
a scheduler suitable for setting an operation sequence of the memory module;
a command generator suitable for generating a command to be applied to the memory module;
a memory interface suitable for communicating with the memory module;
an error history storage unit suitable or storing the error occurrence counts of the memory devices;
a mapping unit suitable for mapping the one or more first data words and the error sensing information to the memory devices and
an error sensing unit suitable for generating the error sensing information based on the one or more first data words and sensing an error of the one or more second data words based on the error sensing information.

13. The memory system of claim 9, wherein as a memory device has a higher error occurrence count among memory devices other than the one or more memory devices, the controller maps higher-significant bits of the multi-bit data of the one or more data words to the memory device.
